(19) United States
(12) Patent Application Publication
(10) Pub. No.: US 2005/0068300 A1
(43) Pub. Date: Mar. 31, 2005

(54) Method and apparatus for controlling dynamic image capturing rate of an optical mouse

(75) Inventors: Ching-Pin Wang, Taipei City (TW); Li-Feng Kuo, Taipei City (TW)

Correspondence Address: BACON & THOMAS, PLLC, 625 SLATERS LANE, FOURTH FLOOR, ALEXANDRIA, VA, 22314, US

(73) Assignee: Sunplus Technology Co., Ltd., Hsinchu (TW)

(21) Appl. No.: 10/857,913

(22) Filed: Jun. 2, 2004

(30) Foreign Application Priority Data
Sep. 26, 2003 (TW) 092126760

(51) Int. Cl. G09G 5/08

(52) U.S. Cl. 345/166

(57) ABSTRACT

A method and apparatus for controlling dynamic image capturing rate of an optical mouse is disclosed. The optical mouse has a light source and an image sensor. The light source is lighted at a lighting frequency such that the image sensor can capture an external image. The method includes the steps: capturing a first image; capturing a second image at a next sampling time for comparing the first image and the second image and thus finding match parts to determine moving distance and speed of the optical mouse; and proportionally adjusting the lighting frequency of the light source and an image capturing rate based on the moving speed.

### BACKGROUND OF THE INVENTION

1. Field of the Invention

The present invention relates to the technical field of optical mouse and, more particularly, to a method and apparatus for controlling dynamic image capturing rate of an optical mouse.

2. Description of Related Art

A typical optical mouse applies a light-emitting diode (LED) to illuminate a mouse pad corresponding to the mouse or other object in order to obtain an image via an image sensor, and then the image sensor captures another image on the mouse pad, thus a moving vector of the optical mouse is found by comparing the two images. The moving vector is the moved distance of the mouse between two sampling points. As shown in FIG. 1, circle A is an image range captured by the image sensor when the LED illuminates on the mouse pad or other object. For image comparison, square range B is applied for consecutive captured images. For illustrative purpose, triangle C is an object in the captured image range. The optical mouse lights the LED at a constant speed. For example, the LED is lighted at time t1′ and t2′ and an image is captured at time t1 and t2 for computing a displacement.

For power consumption, the LED consumes most power (about 60%) in an optical mouse. It is known that the operating speed to a typical mouse is limited by the operating speed of human hand, typically between 2˜6 ips (inch per second). A displacement obtained by such an operating speed and the constant capturing rate will less than 2 dots, and it will not exceed a detectable range. However, because the conventional mouse lights the LED at a constant speed to capture image and compute displacement, it consumes resources like computing capacity and power. Therefore, it is desirable for the above conventional optical mouse to be improved so as to mitigate and/or obviate the aforementioned problems.

### SUMMARY OF THE INVENTION

The object of the present invention is to provide a method and apparatus for controlling dynamic image capturing rate of an optical mouse, which reduces frequency of lighting LED in the optical mouse and the LED power consumption, and which saves much computation time and energy, thereby effectively reducing power consumption to achieve the purpose of saving power.

In accordance with one aspect of the present invention, there is provided a method for controlling dynamic image capturing rate of an optical mouse. The optical mouse has a light source and an image sensor. The light source is lighted at a lighting frequency such that the image sensor can capture an external image. The method includes the steps: (A) capturing a first image; (B) capturing a second image for comparing the first image and the second image and thus finding match parts to determine displacement and moving speed of the optical mouse; and (C) proportionally adjusting the lighting frequency of the light source and an image capturing rate based on the moving speed, and then executing step (B).

In accordance with another aspect of the present invention, there is provided an apparatus for controlling dynamic image extraction rate of an optical mouse. The apparatus includes an image sensor, a light source, a memory and a processor. The image sensor captures images. The light source is lighted at a lighting frequency such that the image sensor can capture external images. The memory stores images captured by the image sensor. The processor is coupled to the memory. When the image sensor captures a current image and stores it in the memory, the processor finds match parts by comparing the current image with a previous image to accordingly determine displacement and moving speed of the optical mouse and thus proportionally adjust the lighting frequency of the light source and an image capturing rate based on the moving speed.

Other objects, advantages, and novel features of the invention will become more apparent from the following detailed description when taken in conjunction with the accompanying drawings.

### BRIEF DESCRIPTION OF THE DRAWINGS

FIG. 1 is a schematic chart of a conventional optical mouse operation;

FIG. 2 is a block diagram of an apparatus for controlling dynamic image capturing rate of an optical mouse in accordance with the invention;

FIG. 3 is a flowchart of a method for controlling dynamic image capturing rate of an optical mouse in accordance with the invention; and

FIGS. 4-5 are schematic diagrams of operations of FIG. 3 in accordance with the invention.

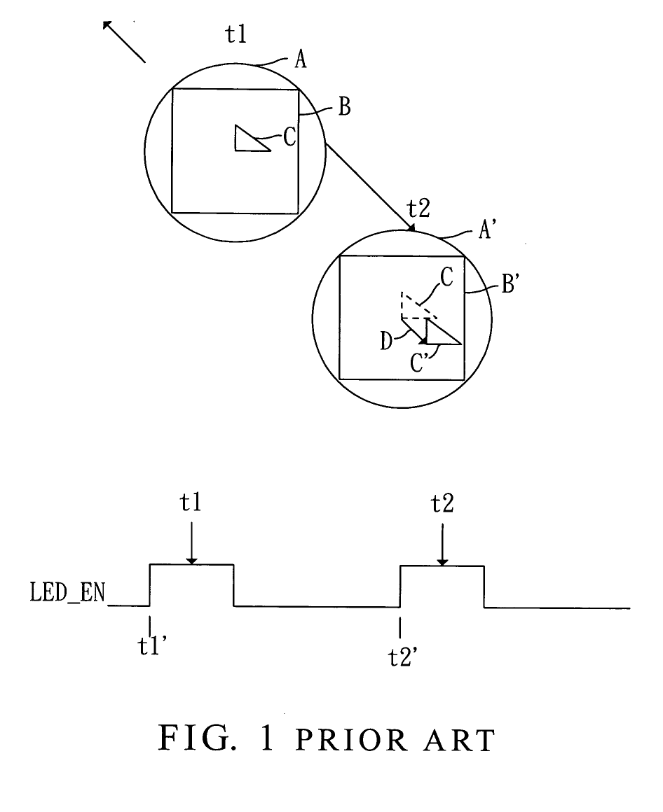

### DETAILED DESCRIPTION OF THE PREFERRED EMBODIMENT

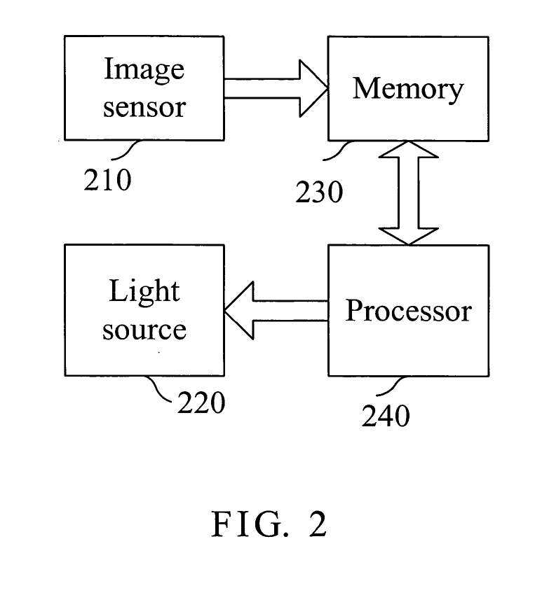

FIG. 2 is a block diagram of an apparatus for controlling dynamic image capturing rate of an optical mouse in accordance with the invention. As shown, the apparatus includes an image sensor 210, a light source 220, a memory 230 and a processor 240. The image sensor 210 is provided to capture images. Preferably, the light source 220 is a light-emitting diode (LED) that is lighted at a lighting frequency such that the image sensor can capture external images. The memory 230 stores images captured by the image sensor 210. The processor 240 is coupled between the memory 230 and the light source 220, for adjusting the lighting frequency of the light source 220 and a capturing rate of the image sensor 210 based on images captured.

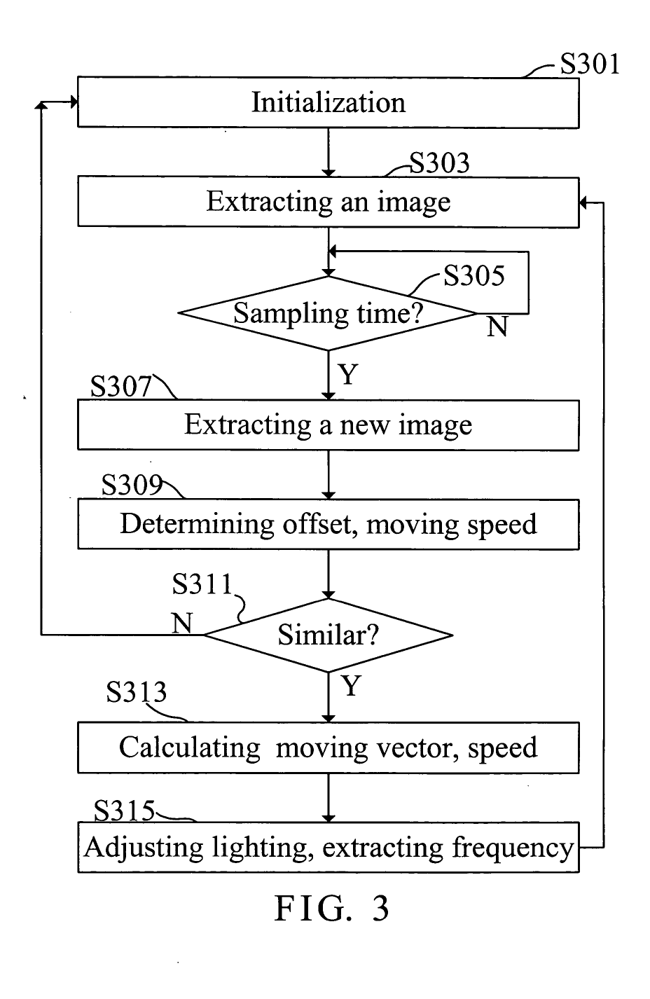

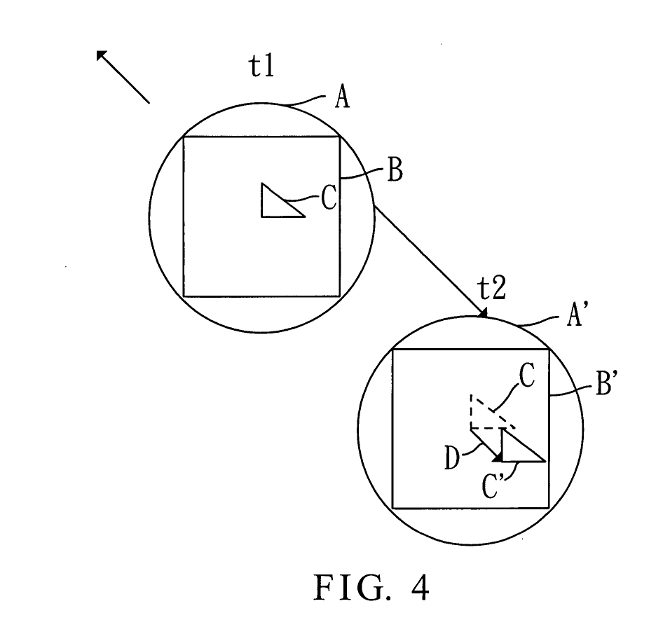

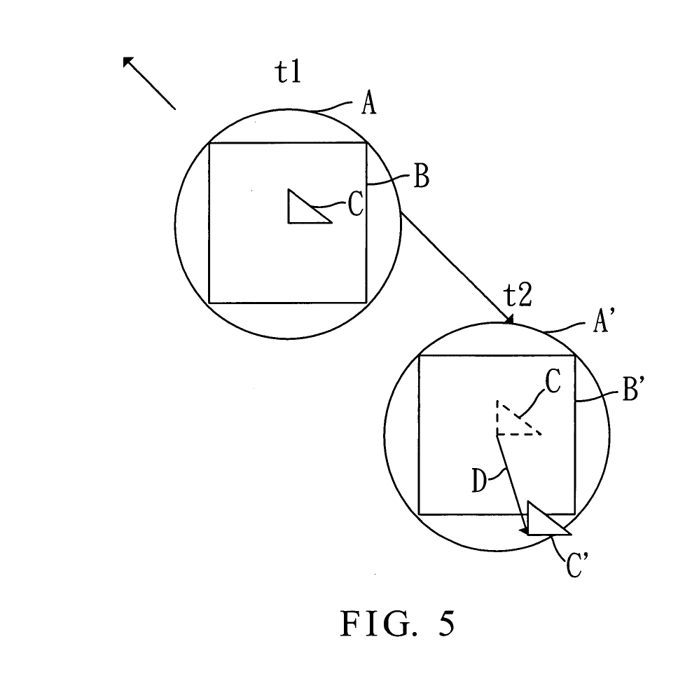

FIG. 3 is a flowchart of a method for controlling dynamic image capturing rate of an optical mouse in accordance with the invention. FIGS. 4-5 are schematic charts of operations of FIG. 3 in accordance with the invention. In FIG. 4, circle A is a captured image range by the image sensor 210 when the LED illuminates on a corresponding mouse pad or other object, square range B is applied for image comparison, and triangle C is an object in the captured image range.

When the optical mouse moves to left up corner, an image captured by the image sensor 210 moves to right down corner, as shown in FIG. 4. Figure indicated by time t1 is an original captured image. Figure indicated by time t2 is a captured image after the optical mouse moves to left up corner. Dotted line in the figure indicated by the time t2 represents a triangle C at an original position and solid line represents a moved triangle C′ at a new position.

As shown in FIG. 3, first, the light source 220 and the image sensor 210 are initialized (step S301) to turn on and off the light source 220 at a lighting frequency ƒ₀. In step S303, the image sensor 210 captures an image at a capturing rate as same as the lighting frequency ƒ₀.

In step S305, it determines whether the sampling time is reached or not. If yes, step S307 is performed. At this point, a new image can be captured by the image sensor 210 because the sampling time is reached and the lighting source 220 bas been lighted.

In step S309, it finds matched parts by comparing images of t1 and t2 to thus determine displacement and moving speed of the optical mouse. A comparison method is applied to compare a comparison range B′ of t2 and a comparison range B of t1 to thus determine the similarity. The comparison method can be a second order momentum method, a mean squared error (MSE) or the like.

After the comparison, the similarity of the comparison ranges B′ and B is determined (step S311). If the comparison ranges B′ and B are similar, it represents that a triangle C′ corresponding to the triangle C included in the comparison range B of t2 can be found in the comparison range B′ of t2. Accordingly, a moving vector D can be computed based on a position change of image and further a moving speed of the optical mouse can be found as v=D/Δt (step S313), where Δt is time difference between two successive images captured by the image sensor 210, i.e., α t=t2−t1.

When the moving speed v increases, it implies that the optical mouse moves quicker. Thus, the capturing rate of the image sensor 210 and the lighting frequency of the light source 220 can be increased to prevent a sampled image from moving outside the range of detectable moving vector. When the moving speed v reduces, it implies that the optical mouse moves slower. Thus, the capturing rate of the image sensor 210 and the lighting frequency of the light source 220 can be reduced for power saving. In this case, the sampled image will not move outside the range of detectable moving vector (step S315).

When the comparison ranges B′ and B are not similar, it represents that the triangle C′ corresponding to the triangle C included in the comparison range B of t1 cannot be found in the comparison range B′ of t2, as shown in FIG. 5. In this case, the sampled image may move outside the range of detectable moving vector, and then step S301 is executed to reset the lighting frequency to a pre-determined value ƒ₀ for re-capturing an image. (step S311)

In view of the foregoing, it is known that the invention can dynamically adjust the capturing rate when an captured image does not move outside a range of detectable moving vector, thereby reducing lighting times of LED and power consumption for lighting, so as to lower sampling and comparison numbers and reduce power consumption for computation.

Although the present invention has been explained in relation to its preferred embodiment, it is to be understood that many other possible modifications and variations can be made without departing from the spirit and scope of the invention as hereinafter claimed.

1. A method for controlling dynamic image capturing rate of an optical mouse, the optical mouse having a light source and an image sensor, the light source being lighted at a lighting frequency such that the image sensor can capture external images, the method comprising the steps of:
(A) capturing a first image;
(B) capturing a second image for comparing the first image with the second image and thus finding match parts to determine displacement and moving speed of the optical mouse; and
(C) proportionally adjusting the lighting frequency of the light source and an image capturing rate based on the moving speed, and then executing step (B).

2. The method as claimed in claim 1, wherein in step (B), the moving speed is: v=D/Δt, where Δt is time difference between two successive images captured by the image sensor and D is displacement of the optical mouse.

3. The method as claimed in claim 1, wherein in step (B), when no match part is found, the lighting frequency is reset to a pre-determined value.

4. An apparatus for controlling dynamic image capturing rate of an optical mouse, comprising:
an image sensor, which captures images;
a light source, which is lighted at a lighting frequency such that the image sensor can capture images;
a memory, which stores the images captured by the image sensor; and
a processor, which is coupled to the memory,
wherein when the optical mouse moves, the image sensor captures an image and stores it in the memory, and the processor finds match parts by comparing the image with a previous image to accordingly determine displacement and moving speed of the optical mouse and thus proportionally adjusts the lighting frequency of the light source based on the moving speed.

5. The apparatus as claimed in claim 4, wherein the moving speed is: v=D/Δt, where Δt is time difference between two successive images captured by the image sensor and D is displacement of the optical mouse.

6. The apparatus as claimed in claim 4, wherein the lighting frequency is reset to a preset value when no match part is found.
